(19) United States
(12) Patent Application Publication
(10) Pub. No.: US 2023/0401589 A1
(43) Pub. Date: Dec. 14, 2023

(54) MACHINE LEARNING MODEL AND NEURAL NETWORK TO PREDICT OBJECT CHARACTERISTICS FROM DIGITAL IMAGE SIMILARITIES

(71) Applicant: ORACLE INTERNATIONAL CORPORATION, Redwood Shores, CA (US)

(72) Inventors: Kiran PANCHAMGAM, Bedford, MA (US); Zhou YANG, Seattle, WA (US); Santosh BAI REDDY, Burlington, MA (US)

(21) Appl. No.: 17/749,388

(22) Filed: May 20, 2022

(51) Int. Cl. G06Q 30/02; G06V 10/20; G06V 10/74

(52) U.S. Cl. CPC G06Q 30/0202; G06V 10/255; B25J 9/1679; G06Q 30/0201; G06V 10/761

(57) ABSTRACT

Systems, methods, and other embodiments for predicting a future characteristic of a target object/product are described based on a digital target image. In one embodiment, the method includes a machine learning model identifying a set of similar known product images by comparing the target product image to a group of known product images. For each similar known product image, product attributes are retrieved including historical characteristic/event data associated with each similar known product image. A predicted characteristic model for the target product is generated which is based on a similarity score combined with the historical characteristic/event data associated with each similar known product image to generate a predicted characteristic for the target product.

### BACKGROUND

Analyzing and/or characterizing digital images is a highly complex task. This is especially true when a database of images includes millions of images of objects and may contain millions of different versions of objects. There may also be many images of the same object from different image views (e.g., front view, back view, side view, etc.). Now extrapolate that to having thousands of different objects in the database of images, which becomes a massive volume of images. This massive volume makes it impossible for a human to even use the images, let alone try to characterize them in any useful manner. Image analysis systems may be used to identify physical features in an image (e.g., facial recognition) but they do not make predictions beyond the physical features in the image.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIGS. 1A and 1B illustrate one embodiment of a method for training a machine learning model with known digital images.

FIG. 2 illustrates one embodiment of a machine learning model method for generating a predicted characteristic for an object/product.

FIG. 3 illustrates an embodiment of a special purpose computing system configured with the example systems and/or methods disclosed.

### DETAILED DESCRIPTION

Systems and methods are described herein that implement a machine learning (ML) model configured with a neural network to predict future characteristics of a new or unknown object/product based on digital images of other similar objects/products. In one embodiment, the present technique trains a machine learning model (including a neural network) with a collection of digital images of known objects/products. The known images may include associated characteristics of each image (e.g., object orientation or image view, etc.) and characteristics of its corresponding object/product shown in the image (e.g., type of object, size, color, historical event data, etc.). There may be multiple images (e.g., tens, hundreds, thousands, or more images) of the same object/product with different characteristics such as different object orientations/views, color, size, shape, etc. and there may be multiple images of multiple different versions of the same object/product that have slightly different features. The machine learning model is used in one embodiment since the machine learning model can learn from its own performance and modify its own predictions.

In one embodiment, for a given image of a new object/product, the machine learning model is configured to identify a set of similar images from the known images of known objects/products. The machine learning model can generate a similarity score between the new object/product image and the set of similar known images. The set of similar images from the collection of known images is identified by the machine learning model by comparing the new object/product image to the known object/product images and determining which images are similar based on at least a threshold similarity score between the new object/product image and each of the known object/product images, hi one embodiment, the similarity is focused on the similarity of the object/product itself in the image and not on any background or incidental items (e.g., a person) in the image. Image portions associated with the background and incidental items may be removed to identify the actual object/product in an image prior to determine similarity.

In one embodiment, the present technique generates a predicted characteristic model that predicts one or more future characteristics for the new object/product in the new object/product image based on the known objects/products from the identified set of similar images. For example, the predicted characteristic model may be generated based on the similarity score of a similar image(s) combined with historical characteristic/event data associated with the known object/product that appears in the identified similar image(s).

In one embodiment, the historical characteristic data of a known object/product includes data of previous events or activities that happened to and/or occurred hi relation to the known object/product. Thus, the historical characteristic data goes beyond physical attributes of the object/product. Accordingly, the present system generates a prediction model that predicts future events or activities that may happen to or be associated with a target object/product based on at least the historical events/activities that occurred to a similar object/product identified in the similar images that are identified.

In one embodiment, the ML model may generate an electronic message with the predicted future characteristics for the new product and transmits the electronic message via a network communication to a remote computer,

### Training of the Machine Learning Model

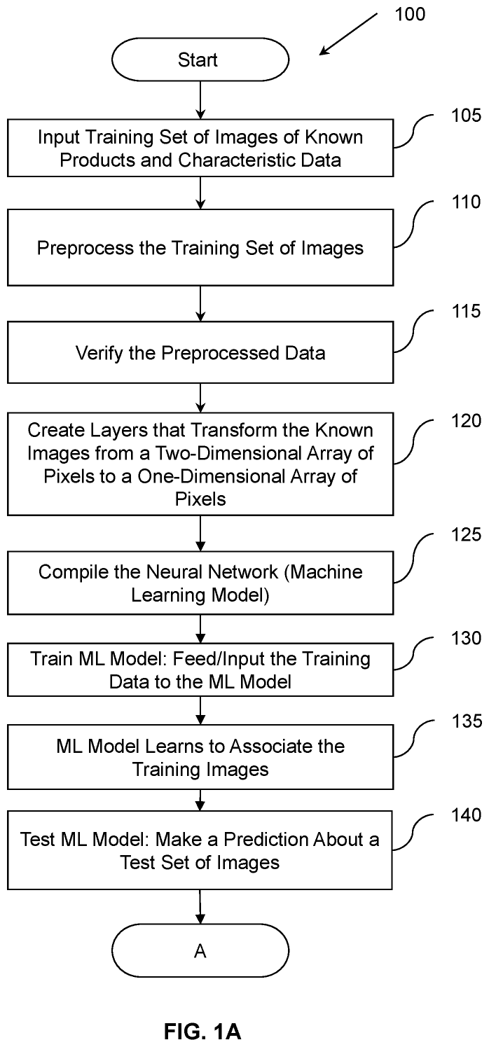

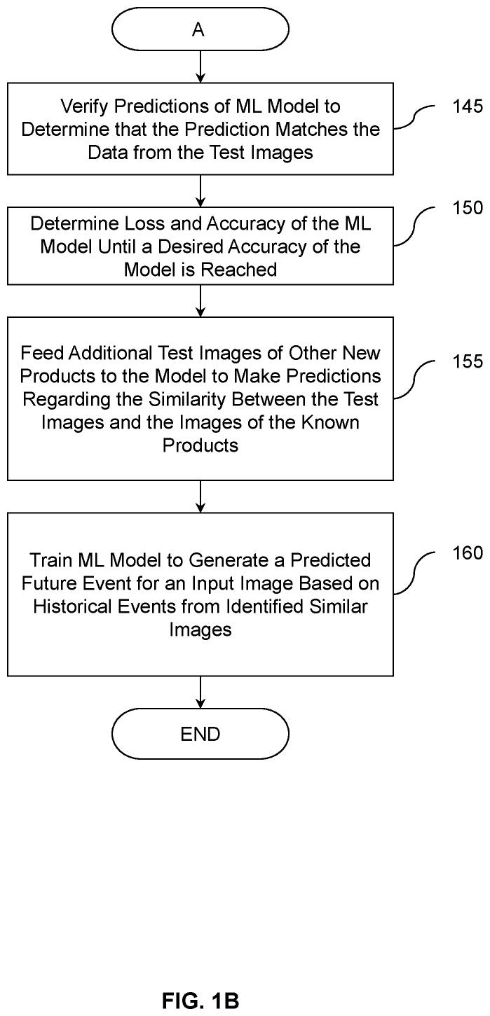

With reference to FIGS. 1A and 1B, one embodiment of a method 100 for training a machine learning model with digital images of known objects/products is illustrated. The method 100 is performed by at least a processor of a computer system that accesses and interacts with memories and/or data storage devices. For example, the processor at least accesses and reads/writes data to the memory and processes network communications to perform the actions of FIG. 1.

To train a neural network model such as a machine learning model to classify images of objects/products, such as clothing, attention is directed to FIGS. 1A and 1B. In one embodiment, the neural network is trained to identify images of object/products based on a collection of known images of known objects/products. The machine learning model is further trained and configured to analyze an input image (e.g., a digital target image of a target object/product being analyzed) and generate a predicted characterization of the target object/product based on identified similar images from the known images of objects/products. Similarity is determined based in part on a similarity score that reflects the degree with which any of the known images of known products match the target image(s) of the new products.

As shown in FIG. 1, at block 105, the method 100 is initiated when a plurality of digital images of known products are input to a machine learning model. The digital images may be retrieved from a database or a memory from a computer system. Typically, tens of thousands (possibly even millions) of images of known products may be inputted to the machine learning model as a training set of data. In one embodiment, the images may be stored as image pixel data in the database, but the system is not limited to such format. Other image formats may be used.

As will be discussed in greater detail later, the known product images are used to train the neural network of the machine learning model. Then the model may be tested with a test set of new product images to evaluate how accurately the neural network learned to classify the known product images and how accurately the neural network identified a product(s) that appears in the new product images.

In one embodiment, each of the images of known products and the new products shows an individual product (e.g., a photograph of a shirt, a purse, shoes, a bag, car, etc.). Any background or incidental items (e.g., a person/model) in the image may be identify and removed so that the actual object/product in the image is identified.

In one embodiment, the ML model includes one or more digital image analysis algorithms configured to extract information from the digital images. The digital images may be processing by pixel analysis. Object-based image analysis may also be applied that groups pixels from a digital image into homogeneous objects that can be used to classify objects. Object statistics associated with image objects may be determined, for example, size, geometry, texture, and context of image objects. The object statistics may also be used to classify the corresponding image object. Thus, in one embodiment, the machine learning model may analyze the digital pixel data of the digital images and include object-based image analysis to group pixels to identify the product in the digital product image.

Furthermore, each of the images of known products and the new product includes data (e.g., metadata) associated to the image that identifies physical attributes/characteristics or features related to that particular known product. The physical attributes may include one or a combination of: a category/type of the product in the image, a sub-category of the product in the image, and descriptive attributes of the product in the image (e.g., product size, color, lengths, brand, material, and/or other features). In one embodiment, known product attributes can be augmented with other information such as brand or manufacturer of the product, country of production, which may be influential in making future predictions about a product.

The known images may also include associated image characteristics of each image, for example, object orientation or image view (e.g., front view/pose of product, rear view/pose of product, side view/pose of product, etc.). In the present context, “pose” refers an image showing a model wearing a clothing product and the pose of the model represents the view of the clothing product.

In one embodiment, one or more images of known products may include historical characteristic data such as historical event data that is associated with the known product in an image. The historical event data of a known object/product may include data of previous events or activities that happened to and/or occurred in relation to the known object/product. Thus, the historical characteristic event data goes beyond physical attributes (e.g., static attributes) of the object/product such as size, shape, color, weight, etc.

In one embodiment, the historical event data may include historical demand of the known product. For example, the historical demand may include a known number of units ordered/sold in previous time periods, locations/regions of demand, etc. The historical demand may be defined based on seasonality, locations, name of the product associated with the known image, historical unit price of the product associated with that known image, brand, and/or other known characteristics associated with the product, etc.

At block 110, the training set of known images (including the image pixel data, image orientation data, and the associated characteristic data of the known products) are preprocessed before training the neural network to verify that the data is in a specified format for the machine learning model.

At block 115, the preprocessed images are verified to ensure that the data is in the correct format.

At block 120, in one embodiment, the neural network (machine learning model) is initially constructed by creating layers that transform the known product images from a two-dimensional array of pixels to a one-dimensional array of pixels. In this manner, the two-dimensional array of pixels is “unstacked”, and the pixels are then “lined up”. This step simply reformats the data. After the pixels are flattened (lined up), the neural network includes a sequence of two layers of “lined up” pixels. These pixel layers are fully connected neural network layers.

At block 125, the neural network (machine learning ML model) is compiled. This may include specifying an optimizer to fit the model and a loss function that is used in optimization. Compiling a neural network is beyond the scope of this disclosure and is not described in detail.

At block 130, training of the neural network is initiated by feeding the training data (data from the known product images) to the ML model. In one embodiment, the neural network may be trained using known product images. In another embodiment, a neural network (e.g., RESNET-50) may be used and trained by machine learning on a random set of known product images.

At block 135, the ML model learns to associate the training images. In one embodiment, the ML model is trained to associate images that have the same image view/pose of a particular product. As such, the ML mode may ignore poses/views of the particular product in the known images that are not relevant to or different than the pose/view of the particular product in other known product images.

In one embodiment, if the pose/view in an image of a known brand X product is a front pose/view, the ML model will ignore (and not associate as being similar) other images of the same brand X product that have different poses/views such as a side pose and/or a back pose. Thus, the ML model is trained that a front view image of a product is not regarded as similar to a side view image of the same product.

As such, the ML model learns and defines a set of similar product images that have the same pose/view of the same product. For example, a known product may have a number of images showing 4-5 poses (e.g., front, back, side) of the known product. This information can be used to exclude those images with non-similar poses from the known product images with similar poses which should improve the accuracy (and speed of image processing) of the model by removing unnecessary poses from being considered.

At block 140, the ML model may be tested for how accurately it identifies and generates similarity scores for known images of products that are similar to an input test image of a product. As used herein, a known image is “similar” to an input test image if the product in the known image is similar to or the same as the product in the input test image. For example, if the input test image includes a photo of a men's short sleeve shirt, color red, and has no markings, then a known image that is identified as being similar by the ML model should have a photo of a men's short sleeve shirt, color red, with no markings. The ML model is expected to generate a high similarity score for such a closely matching product image.

To begin a test, for example, a request is sent to the ML model to make a similarity prediction about a test set of product images and the known product images. For example, the test set may include digital images (and data about each image) of a new product. The machine learning model may analyze the digital pixel data of the digital images and include object-based image analysis to group pixels to identify the product in the digital product image.

In one embodiment, the similarity prediction may include generating a similarity score that represents a statistical similarity between each of the test product images and the known product images.

In one embodiment, when using the neural net that has been trained by machine learning on a random set of product images, a k-nearest neighbor algorithm (k-NNA) is performed on deep features of the known images (features in the one layer of pixels before the last layer of pixels). Based on the similarity scores or k-NNA, a top number of k (e.g., k=5) known images identified as being similar to the input test image are identified by the ML model.

With reference to FIG. 1B, the process from FIG. 1A continues. At block 145, the predictions from the ML model are verified to determine that the prediction of similar images matches the test product in the input test images. This may include displaying the identified top similar images on a display device along with the corresponding test image. The displayed images may then be visually compared to verify the accuracy of the identified similar images. The accuracy or inaccuracy of any identified image may be marked and fed back to the ML model to make appropriate learning adjustments on determining similarities.

At block 150, as the model trains, a loss and accuracy of the model may be determined until a desired accuracy of the model is reached. In one embodiment, the ML model is evaluated on a loss function that equals a Cross-entropy loss and Triplet loss. For example, the cross-entropy loss function is to evaluate the prediction results on the training set. Triplet loss is used to incorporate the information obtained from different poses/views of the known images. In one embodiment, Loss=Cross Entropy Loss+Triplet Loss

At block 155, with the ML model trained for identifying similar images, additional test images of other new products can be input into the ML model in order to make predictions (similarity scores) regarding the similarity between the test images of the other new products and the images of the known products. At the end of block 155, the ML model should be initially trained to identify similar images of similar products.

At block 160, the ML model is further trained to generate a predicted future event or characteristic for an input product image based on at least historical characteristics/events associated with a set of identified similar products from the identified similar images. In one embodiment, the known product images used by the ML model include (or have associated/linked thereto) historical characteristic/event data of the known product shown in the known product image.

For example, the historical event data of a known object/product may include data of previous events or activities that happened to and/or occurred in relation to the known object/product. Thus, the historical event data goes beyond physical attributes (e.g., static attributes) of the object/product such as size, shape, color, weight, etc.

Accordingly, for an input target object/product, the ML model is trained to generate a prediction model to predict a future characteristic/event that may happen to or be associated with the target object/product based on the historical events/activities that occurred to a similar object/product identified in the similar images that are identified by the ML model.

In one embodiment, the historical characteristic/event data includes historical demand data of a known object/product. The prediction model generated for a target object/product includes a predicted demand model that represents a predicted future demand for the target object/product. Thus, for example, when a new product is developed, an image of the new product may be inputted to the ML model. The ML model generates a predicted demand for the new product based at least on historical demand from a set of similar products that were identified by the ML model from similar images. The predicted future demand may then be used as a guidance for the new product to determine actions such as ordering numbers of product units, locations of demand, time periods of demand (seasonality), and/or assigning initial prices to the new product. For example, an initial price of a new product may be inferred and predicted from the historical data from similar products.

In one embodiment, the known product attributes can be augmented with information such as brands, country of production, and/or other attributes, which are believed influential in predicting and assigning initial prices of new products.

### Operation of Machine Learning Model

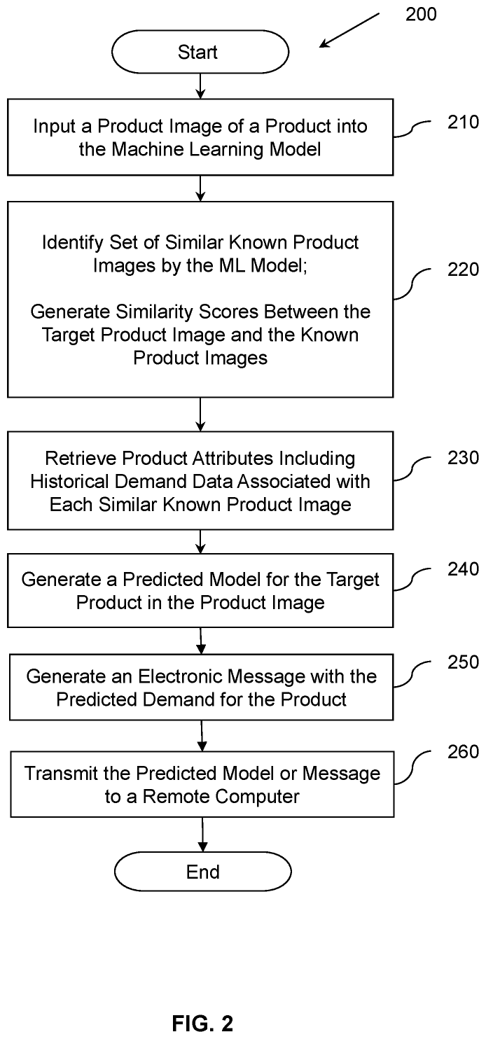

Once the machine learning model has been initially trained, attention is now directed to FIG. 2. With reference to FIG. 2, one embodiment of a method 200 for generating a predicted characteristic of an unknown object is illustrated. In one embodiment, the predicted characteristic is described as a predicted demand for a product, but is not limited thereto since the machine learning model may be trained based on other types of characteristics. The method 200 is performed by at least the trained ML model including a processor of a computer system that accesses and interacts with memories and/or data storage devices. For example, the processor at least accesses and reads/writes data to the memory and processes network communications to perform the actions of FIG. 2.

With reference to FIG. 2, at block 210, the method 200 is initiated when a digital product image of a new product is input into the machine learning model. The input image of a product will also be referred to as a target image or target product image. In one embodiment, the machine learning model may analyze the digital pixel data of the target image and include object-based image analysis to group pixels to identify the new product in the digital product image.

At block 220, the machine learning model then identifies a set of similar product images from the database of known product images by comparing digital image data of the target product image to the digital image data of the known product images in the database. In one embodiment, pixels and other digital information from the target product image are analyzed to identify digital object statistics of the target product so that the target product features may be identified.

The ML model compares and attempts to match the new product in the target image to products in the known product images based on at least the digital object statistics. The ML model generates a similarity score for each known product image based on how well the known product characteristics/attributes of the known product image statistically match the product characteristics/attributes of the target image.

As discussed above, the similarity prediction is a similarity score that represents a statistical similarity between the target product image and the known product images. A final set of best matching known images are selected as the similar product images. The best matching known images are, for example, the known images that received a similarity score above a threshold similarity score.

In one embodiment, when using the neural net that has been trained on a random set of product images, a k-nearest neighbor algorithm (k-NNA) is performed on the deep features of the images (e.g., features in the one-pixel layer before the last pixel layer). Based on a threshold similarity score or k-NNA, the top k (e.g., k=5) known product images that are similar to the target product image can be identified.

Furthermore, as discussed above, in one embodiment, known images that include the same or similar product as the target product image, but have a different pose/view of the product may be excluded from the final set of similar images. This will reduce computing resources and processor time.

Returning to FIG. 2, at block 230, data associated to each identified similar image from the final set of similar images is retrieved. For example, the machine learning model retrieves the historical characteristics/events (described previously) including historical demand data (in one embodiment) that is associated with each similar product image. In one embodiment, other product attributes/characteristics of a similar image can also include a product image category, a product image sub-category, and descriptive attributes of the product image.

In one embodiment, the historical demand data of the similar known product, for example, may include one or more combinations of other types of historical data relating to a product. For example, the historical demand data may include a number of units ordered/sold in a time period, locations of demand, seasonality, historical prices, price elasticity, and/or base demand, etc.

At block 240, the machine learning model generates a predicted characteristic model for the target product in the target product image based on at least the historical demand data of the similar products associated with the identified similar images. In one embodiment, the predicted characteristic model may be a predicted demand model for the target product. The predicted characteristic/demand model may include a predicted demand is based on the types and amounts of demand that happened historically to each known product in the final set of known products that were identified as being similar to the target product.

In one embodiment, the predicted demand model is generated by using the similarity score of each identified similar known product image combined with (e.g., weighted by) the historical demand data associated with the corresponding similar known product. For example, the historical demand from a more similar known product (e.g., better/higher similarity score) is given more weight in the predicted demand than the historical demand from a less similar known product (e.g., lower similarity score). One example is shown in Equation 1 below.

In this manner, the predicted demand model for the target product predicts a future/forecast demand for the target product, for example, including any one or a combination of: number of product units to order, regional locations for product units, seasonality of demand, and/or initial product price. As such, the predicted demand model may be used as a guidance to plan for the target new product, order and coordinate when, where, and how many product units are to be ordered, shipped to, and/or boated in different regional areas (on a location-by-location basis), and/or estimated initial prices, etc. Thus, an initial price of a new target product with no known market data may be inferred and predicted by the ML model from the historical data of the identified similar products.

In one embodiment, the ML model may be configured to generate the predicted demand model as follows. Using the similarity score for a known product associated with an identified similar known product image, the predicted demand model is trained using the known product images associated with a known product to assess the predictive power of the similarity scores.

For example, suppose a new product (i) associated with a new product image is determined to be similar to known products (j1, j2, jk) associated with known product images. The similarity score between new product i and a known product j1 can be expressed as sim_i_j1. Each similarity score may be used to weight the corresponding historical data (historical demand) of the similar known product. Thus, a greater similarity score will increase the influence of the corresponding historical demand data, and vice versa. An example of a predicted demand model is expressed in Equation 1:

Demand for a new product(i) at store s=function(sim_i_j1*demand for known product j1),(sim_i_j2*demand for known product j2), . . . (sim_i_jk*demand for known product jk). Equation 1

In one embodiment, the predicted demand model may be generated for a specific selected demand feature. For example, one predicted characteristic model may be generated to predict an initial price for the new product where “demand for known product” is based on historical demand and associated historical unit price. Another predicted model may be generated for forecasting a demand quantity where “demand for known product” is historical demand quantities. Each predicted demand may be combined into a final predicted demand model to identify multiple predicted future characteristics of the target product.

In one embodiment, the predicted demand model may be augmented or otherwise adjusted with other product features of the similar known products such as category, seasonality, etc. In one embodiment, the generated demand model for the target product may be a linear additive model.

In another embodiment, a selected brand of product (e.g., a competitor brand product) that are identified as similar known products to the new target product may be accounted for and used to adjust the predicted demand model. For example, the predicted demand model (e.g., from equation 1) may be adjusted by adding a negative of the similarity score of the competitor product combined/multiplied by the historic demand of the competitor product. In other words, the predicted demand model may be negatively adjusted by the similarity score and historic demand combination of a similar image that is associated with the selected brand (e.g., competitor brand).

At block 250, after the predicted demand model is generated, the machine learning model may output the predicted model for the new product. The ML model may also generate an electronic message including content of the predicted demand for the new product. As previously stated, the predicted demand model may be used as a guidance to plan for a target new product, order and coordinate when, where, and how many product units are to be ordered, shipped to, and/or located in different regional areas (on a location-by-location basis), and/or estimate initial prices, etc. Thus, hi one embodiment, an initial price of a new target product with no known market data may be predicted by the ML model in the predicted demand model as described above.

At block 260, the machine learning model may transmit the predicted model and/or the electronic message to a remote computer via a network communication over a network. The machine learning model may also generate and display the predicted model on display device.

As another example, the method of FIG. 2 is described where the new target product is a new shirt design or style. With reference to FIG. 2, at block 210, the method 200 is initiated when a product image of the new shirt design or style is input into the machine learning model.

At block 220, the machine learning model then identifies a set of similar, known shirt images by comparing the new shirt image to the database of known images. The database of known images may be filtered based on product category to cause the comparing steps and generating of similarity scores to be limited to only the known images with a shirt category. Furthermore, as discussed above, in one embodiment, known images of shirts that have poses/views that are different than the pose/view of the input shirt image may also be excluded.

For the remaining known shirt images, the ML model generates a similarity score for each as compared to the new shirt image. As discussed above, in one embodiment, each similarity score represents the statistical similarity between the new shirt image and one known shirt image.

The similarity scores of the known shirt images may be filtered based on at least a threshold similarity score. Using the threshold, a top set of N (e.g., 4, 5, or 6, etc.) similar images may be selected from the most closely similar shirt images (e.g., highest greatest similarity scores). The top set forms the identified set of similar images.

Returning to FIG. 2, at block 230, the machine learning model retrieves product attributes including historical demand data associated with each image in the identified set of similar images. In one embodiment, the product attributes can also include a shirt category (i.e., tops), a product item image sub-category (i.e., blouse), and descriptive attributes of the shirt image (i.e., sleeve length, sleeveless, etc.). In another embodiment, the images of known shirts may also include data related to demand of the shirt associated with the known shirt image based on seasonality, the name or brand of the shirt associated with the known shirt image, a historical unit price of the shirt associated with the known shirt product image, etc.

At block 240, the machine learning model generates a predicted demand model for the new shirt in the new shirt image. In one embodiment, the predicted demand model is generated using the similarity score of a similar known image (from the identified similar images) combined with the historical demand data associated with that similar known shirt image.

For example, suppose a new shirt (i) shown in a shirt image inputted to the ML model is determined to be similar to known shirts (j1, j2, . . . jk) associated with known shirt images. The similarity score between the new shirt (i) and a known shirt j1 can be expressed as sim_i_j1. An example of a predicted demand model for the new shirt is expressed in Equation 2:

Demand for a new shirt(i) at store s=function(sim_i_j1*demand for known shirt j1),(sim_i_j2*demand for known shirt j2), . . . (sim_i_jk*demand for known shirt jk). Equation 2

In one embodiment, the predicted demand model may be augmented with other product features of the similar shirts such as category, seasonality, etc. In one embodiment, the generated demand model for the target product may be a linear additive model.

At block 250, after the predicted demand model is generated, the machine learning (ML) model may output the predicted model for the new shirt to a remote computer and/or a display device. The ML model may also generate an electronic message including content of the predicted demand for the new shirt. The electronic message may then be transmitted via a communication network to a destination (e.g., email address, text, SMS message, online account, etc.) that is accessible by a remote computer/device.

### Predicted Model for Inventory Control—Robotic Mechanisms

In one embodiment, the predicted demand model may be used to control an inventory of the associated product. For example, after the predicted demand model and/or the electronic message is received at a remote computer, the predicted demand model may cause instructions to be sent to one or more inventory control systems and/or inventory databases to assign the predicted characteristic (e.g., a predicted initial price) to the data records associated with the target product (e.g., the new shirt) as identified in the predicted demand model.

In another embodiment, the predicted demand model may cause instructions for an order to be generated and/or cause a robotic mechanism to retrieve quantities of the target product. For example, the order may be generated to include a quantity of a target product as defined in the predicted demand model for the target product. The order may then be prepared and fulfilled by retrieving the quantity of the target product and (if applicable) transporting the quantity to a destination as identified in the predicted demand model. The remote computer may be associated with a warehouse (or fulfillment center) or a sales channel (retail store) and control inventory.

With reference to the new shirt example, after the predicted demand model and/or the electronic message is received at the remote computer, an order is fulfilled by retrieving a quantity of new shirts. If the order is sent to a warehouse (or fulfillment center), warehouse-management software receives the order, and systems at the warehouse fulfill the order by retrieving the units of the new shirts from a unit storage location, packaging the new shirts, and preparing them for shipping. If the order is sent to the sales channel (store), the order may be fulfilled at the store. In one embodiment, the systems are controlled at least in part by the instructions in the order.

In one embodiment, the systems for processing the order may include, for example, automated robotic machines or mechanisms configured to locate and retrieve the target product from a warehouse or store locations based on the order. The retrieved target products may then be delivered by the robotic mechanism to automated packaging mechanisms that package the retrieved new shirts in the warehouse.

In one embodiment, the robotic mechanisms may include one or more robots configured to navigate throughout a given warehouse or store, locate and retrieve items, and carry items to a destination. Each robot may include at least a body structure, a power source, a control interface, a wired/wireless communication interface, a drive device to move the robot, a navigation device, one or more sensors, and/or a balance device. Of course, the robot may be configured in different ways and multiple different types of robots may be operating together in the robotic mechanism of the warehouse or store.

In one or more embodiments, the robotic mechanisms may include one or more of the following systems. Automated Guided Vehicles (AGVs) for transporting materials, supplies, and inventory within warehouse or store facilities. An AGV may be configured to autonomously navigate warehouse or store facilities by following defined routes marked by wires, magnetic strips, tracks, sensors embedded in the floor or other physical guides. The AGV may also be navigated by a defined map of the warehouse or store based on a coordinate system and a tracked location of the AGV. Cameras may also be used to navigate an AGV.

Another robotic mechanism is Automated Storage and Retrieval Systems (AS/RS) which may include a group of computer-controlled systems that automate inventory management and store/retrieve goods on demand from storage locations in the warehouse or store. The AS/RS may operate either as cranes or shuttles on fixed tracks and can traverse product aisles and vertical heights to remove items or drop off items from storage. Another robotic mechanism is articulated robotic arms that are a type of pick-and-place robot. These arms can move, turn, grab/release, lift and move items with, for example, multi-jointed limbs used to manipulate products.

After the retrieved products (shirts) are transported to a packaging area of the warehouse (block 270), the products (shirts) for the order are packaged by an automated system. This may include cartonization software that determines quantity, size, and type of container required to package the order, and/or bagging machines that help speed up packaging operations. As discussed above, after the retrieved products (shirts) are transported to the sales channel (retailer's store), the retrieved products (shirts) can then be transported to the display area of the store, and the retrieved products (shirts) can be placed on a designated display area of the store.

The packaged order is transferred to a shipper, or if the retailer has its own shipment operation, then the retailer's own trucks will take the shipment. The status of the order is changed to “in transit” in the inventory-management system. The order arrives at the store it is destined for. Finally, the computerized management system software then updates the inventory position of the retrieved products (shirts) at the sales channel.

On the other hand, if the order is sent to a manufacturer, then the sequence of steps is similar except that the manufacturer is responsible for acting as a fulfillment center and fulfilling the order.

### Computing Device Embodiment

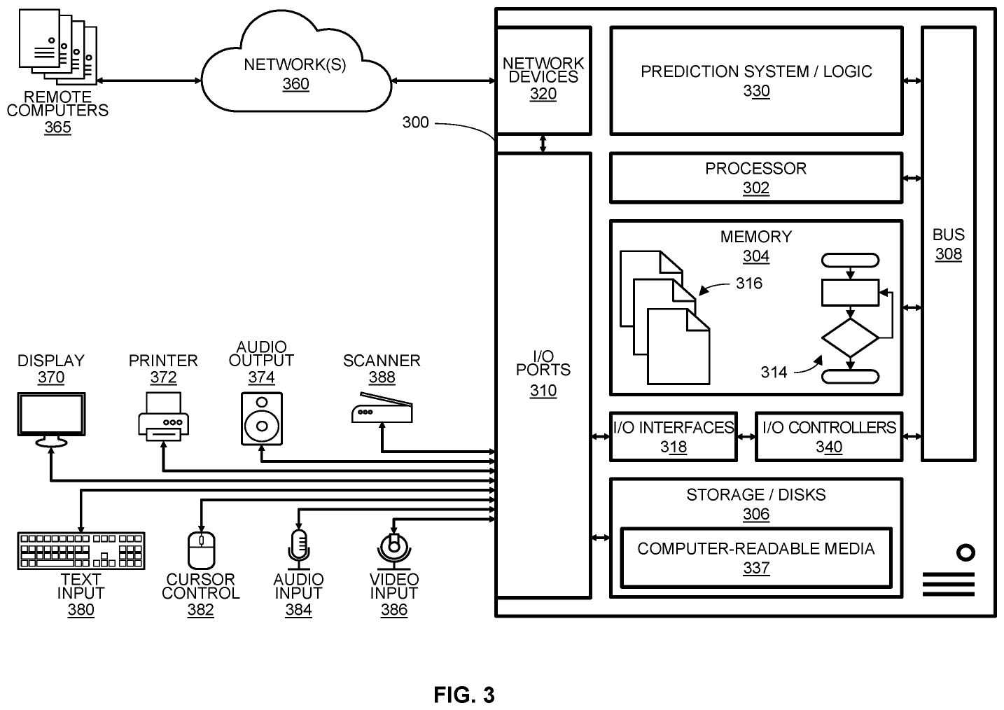

FIG. 3 illustrates an example computing device that is configured and/or programmed as a special purpose computing device with one or more of the example systems and methods described herein, and/or equivalents. The example computing device may be a computer 300 that includes at least one hardware processor 302, a memory 304, and input/output ports 310 operably connected by a bus 308. In one example, the computer 300 is implemented with a prediction system or logic 330 configured to facilitate a machine learning (ML) model configured to predict future characteristics of a new or unknown object/product as described with reference to FIGS. 1A, 1B, and/or 2.

In different examples, the logic 330 may be implemented in hardware, a non-transitory computer-readable medium 337 with stored instructions, firmware, and/or combinations thereof. While the logic 330 is illustrated as a hardware component attached to the bus 308, it is to be appreciated that in other embodiments, the logic 330 could be implemented in the processor 302, stored in memory 304, or stored in disk 306.

In one embodiment, logic 330 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to predict future characteristics such as a product demand as described herein. The means may also be implemented as stored computer executable instructions that are presented to computer 300 as data 316 that are temporarily stored in memory 304 and then executed by processor 302.

Logic 330 may also provide means (e.g., hardware, non-transitory computer-readable medium that stores executable instructions, firmware) for predicting characteristics of a new or unknown object as described here.

Generally describing an example configuration of the computer 300, the processor 302 may be a variety of various processors including dual microprocessor and other multi-processor architectures. A memory 304 may include volatile memory and/or non-volatile memory. Non-volatile memory may include, for example, ROM, PROM, and so on. Volatile memory may include, for example, RAM, SRAM, DRAM, and so on.

A storage disk 306 may be operably connected to the computer 300 via, for example, an input/output (I/O) interface (e.g., card, device) 318 and an input/output port 310 that are controlled by at least an input/output (I/O) controller 340. The disk 306 may be, for example, a magnetic disk drive, a solid-state disk drive, a floppy disk drive, a tape drive, a Zip drive, a flash memory card, a memory stick, and so on. Furthermore, the disk 306 may be a CD-ROM drive, a CD-R drive, a CD-RW drive, a DVD ROM, and so on. The memory 304 can store a process 314 and/or a data 316, for example. The disk 306 and/or the memory 304 can store an operating system that controls and allocates resources of the computer 300.

The computer 300 may interact with, control, and/or be controlled by input/output (I/O) devices via the input/output (I/O) controller 340, the I/O interfaces 318, and the input/output ports 310. Input/output devices may include, for example, one or more displays 370, printers 372 (such as inkjet, laser, or 3D printers), audio output devices 374 (such as speakers or headphones), text input devices 380 (such as keyboards), cursor control devices 382 for pointing and selection inputs (such as mice, trackballs, touch screens, joysticks, pointing sticks, electronic styluses, electronic pen tablets), audio input devices 384 (such as microphones or external audio players), video input devices 386 (such as video and still cameras, or external video players), image scanners 388, video cards (not shown), disks 306, network devices 320, and so on. The input/output ports 310 may include, for example, serial ports, parallel ports, and USB ports.

The computer 300 can operate in a network environment and thus may be connected to the network devices 320 via the I/O interfaces 318, and/or the I/O ports 310. Through the network devices 320, the computer 300 may interact with a network 360. Through the network, the computer 300 may be logically connected to remote computers 365. Networks with which the computer 300 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A method performed by a computing system comprising at least one processor, the method comprising:
inputting, to a machine learning model, a target object image in digital form that represents a target object;
comparing, by the machine learning model, at least digital pixel data of the target object image to digital pixel data from a group of known object images;
generating, by the machine learning model, a similarity score between the target object image and one or more known object images from the group of known object images based at least on the digital pixel data;
identifying, by the machine learning model, a set of similar object images based at least in part on the similarity score of the one or more known object images;
for each similar object image of the set of similar object images, retrieving object attributes including historical event data associated with each similar object image;
generating a predicted characteristic model including a predicted characteristic for the target object represented in the target object image based at least on the historical event data for a given similar object combined with the similarity score of the given similar object;
generating an electronic message with the predicted characteristic for the target object; and
transmitting the electronic message to a remote computer.

2. The method of claim 1,
wherein the machine learning model is configured with a neural network model that is trained to classify images of objects; and
adjusting, by the machine learning model, the predicted characteristic for the target object with additional object attributes from the set of similar object images prior to generating the electronic message.

3. The method of claim 1, further comprising:
analyzing, by the machine learning model, the digital pixel data of the object image including object-based image analysis to group pixels to identify the target object in the target object image.

4. The method of claim 1, wherein generating the predicted characteristic model for the target object includes weighting the historical event data for a given similar object with the similarity score of the given similar object.

5. The method of claim 1, wherein the target object is a target product, and wherein generating the predicted characteristic further comprises:
configuring the predicted characteristic model to generate the predicted characteristic as a predicted demand for the target product (i), at a first store (S) which is based on a function (sim_i_j1*demand for a known product j1, (sim_i_j2*demand for a known product j2), . . . (sim_i_jk*demand for a known product jk),
where the target product (i) is associated with the target product image which is determined to be similar to the known products (j1, j2, . . . jk) associated with the known product images, and
sim_i_j1, sim_i_j2, . . . and sim_i_jk represent the similarity scores between the target product (i) and each of the known products (j1, j2, . . . jk) from the set of similar product images.

6. The method of claim 1, wherein the identifying step further comprises:
removing similar object images from the set of similar object images that do not contain an image orientation that is similar to an image orientation in the target object image.

7. The method of claim 1, further comprising:
causing a robotic mechanism to retrieve quantities of the target object from a storage location based at least upon the predicted characteristic model.

8. A non-transitory computer-readable medium storing computer-executable instructions that, when executed by a computer including a processor, cause the computer to perform functions configured by the computer-executable instructions, wherein the instructions comprise:
input, to a machine learning model, a target product image in digital form that represents a target product;
identify, by the machine learning model, a set of similar product images by comparing digital pixel data of the target product image to digital pixel data of known product images and generating a similarity score between the target product image and each of similar product images;
for each similar product image of the set of similar product images, retrieve product attributes including historical event data associated with each similar product image; and
generate a predicted characteristic for the target product represented in the target product image based at least on the historical event data for a given similar product combined with the similarity score of the given similar product.

9. The non-transitory computer-readable medium of claim 8, further comprising instructions that, when executed by at least the processor, cause the processor to:
adjust the predicted characteristic for the target product with additional product attributes from the set of similar product images.

10. The non-transitory computer-readable medium of claim 8, further comprising instructions that, when executed by at least the processor, cause the processor to:
analyze, by the machine learning model, the digital pixel data of the product image including object-based image analysis to group pixels to identify the target product in the product image.

11. The non-transitory computer-readable medium of claim 10, further comprising instructions that, when executed by at least the processor, cause the processor to:
negatively adjust the predicted characteristic by the similarity score and historic event combination of a similar image that is associated with a selected brand of a known product.

12. The non-transitory computer-readable medium of claim 8, further comprising instructions that, when executed by at least the processor, cause the processor to:
generate the predicted characteristic as a predicted demand for the target product, product (i), at a first store (S) which is based on a function (sim_i_j1*demand for a known product j1, (sim_i_j2*demand for a known product j2), . . . (sim_i_jk*demand for a known product jk),
where the target product (i) is associated with the target product image which is determined to be similar to the known products (j1, j2, . . . jk) associated with the known product images, and
sim_i_j1, sim_i_j2, . . . and sim_i_jk represent the similarity scores between the target product (i) and each of the known products (j1, j2, . . . jk).

13. The non-transitory computer-readable medium of claim 8, further comprising instructions that, when executed by at least the processor, cause the processor to:
remove similar product images from the set of similar product images that do not contain an image orientation that is similar to an image orientation in the target product image.

14. The non-transitory computer-readable medium of claim 8, further comprising instructions that, when executed by at least the processor, cause the processor to:
generate instructions to cause a database to assign the predicted characteristic to data records associated with the target product.

15. A computing system, comprising:
at least one processor connected to at least one memory;
a non-transitory computer readable medium including instructions stored thereon that, when executed by the at least one processor, cause the at least one processor to:
input, to a machine learning model, a target product image in digital form that represents a target product;
compare, by the machine learning model, at least digital pixel data of the target product image to digital pixel data from a group of known product images;
generate, by the machine learning model, a similarity score between the product image and one or more known product images from the group of known product images based at least on the digital pixel data;
identify, by the machine learning model, a set of similar product images based at least in part on the similarity score of the one or more known product images;
for each similar product image of the set of similar product images, retrieve product attributes including historical event data associated with each similar product image; and
generate a predicted characteristic model including a predicted characteristic for the target product represented in the target product image based at least on the historical event data for a given similar product combined with the similarity score of the given similar product.

16. The computing system of claim 15, wherein the instructions further include instructions that, when executed by at least the processor, cause the processor to:
analyze, by the machine learning model, the digital pixel data of the product image including object-based image analysis to group pixels to identify the target product in the product image.

17. The computing system of claim 15, wherein the instructions further include instructions that, when executed by at least the processor, cause the processor to:
generate an electronic message with the predicted characteristic for the target product; and
transmit the electronic message to a remote computer.

18. The computing system of claim 15, wherein the instructions to generate the predicted characteristic model further include instructions that, when executed by at least the processor, cause the processor to:
combine the similarity score with the historical event data for a given similar product by weighting the historical event data with the similarity score.

19. The computing system of claim 15, wherein the instructions further include instructions that, when executed by at least the processor, cause the processor to:
remove similar product images from the set of similar product images that do not contain an image orientation that is similar to an image orientation in the target product image.

20. The computing system of claim 15, wherein the instructions further include instructions that, when executed by at least the processor, cause the processor to:
negatively adjust the predicted characteristic by the similarity score and historic event combination of a similar image that is associated with a selected brand of a known product.
